(19) United States
(12) Patent Application Publication
(10) Pub. No.: US 2009/0325008 A1
(43) Pub. Date: Dec. 31, 2009

(54) REFORMER

(75) Inventors: Stefan Kah, Hannover (DE); Johannes Eichstaedt, Neubrandenburg (DE); Andreas Lindermeir, Goslar/Oker (DE); Marco Muehlner, Raduhn (DE)

Correspondence Address: DICKINSON WRIGHT PLLC, 1875 Eye Street, NW, Suite 1200, WASHINGTON, DC, 20006, US

(73) Assignee: ENERDAY GmbH, Stockdorf (DE)

(21) Appl. No.: 12/440,221

(22) PCT Filed: Aug. 1, 2007
(86) PCT No.: PCT/DE2007/001365

§ 371 Date: Jun. 25, 2009

(30) Foreign Application Priority Data
Sep. 14, 2006 (DE) 10 2006 043 128.6

(51) Int. Cl. H01M 8/18

(52) U.S. Cl. 429/19

(57) ABSTRACT

The invention relates to a reformer (10) comprising a first media feeder portion (12) for receiving a supply of fuel (14) and oxidant (16), following the first media feeder portion an oxidation zone (18) in which the media supplied to the first media feeder portion react at least in part into flue gas (20), a second media feeder portion (22) for receiving at least a supply of fuel (24), a mixture formation zone following the oxidation zone (18) and the second media feeder portion and in which a fuel/flue gas mixture (28) can be generated, and following the mixture formation zone (26) a reforming zone in which the fuel/flue gas mixture (28) is catalytically reformable.

In accordance with the invention it is provided for that the volume of the mixture formation zone is in the range of 20 to 90 cm³.

The invention relates to a reformer comprising a first media feeder portion for receiving a supply of fuel and oxidant, following the first media feeder portion an oxidation zone in which the media supplied to the first media feeder portion react at least in part into flue gas, a second media feeder portion for receiving at least a supply of fuel, a mixture formation zone following the oxidation zone and the second media feeder portion and in which a fuel/flue gas mixture can be generated, and following the mixture formation zone a reforming zone in which the fuel/flue gas mixture is catalytically reformable.

Such reformers find application to generate from hydrocarbons such as natural gas, gasoline or Diesel a hydrogen rich reformate for supplying to the anode end of a fuel cell to generate electricity. The aforementioned multistage fuel feeder described, for example, in DE 103 59 205 A1, serves particularly to homogenize the temperature profile. In the oxidation zone, part of the fuel supplied in all is fully oxidized with air and is streaming past the reforming zone arranged concentrically to the oxidation zone during and after the reaction. This can heat up the catalyst. Before entry of the flue gas having resulted from oxidation into the catalyst the flue gas is mixed with further fuel so that the fuel/flue gas mixture fed to the reforming zone is available. The total amounts of feed air and feed fuel dictate the parameter of the air ratio important for reforming. In all the air ratio should be in the region of 0.4. For further tweaking the air ratio it may also be provided for that a further oxidant feed is provided in the second media feeder portion.

It is in conjunction with the system as described that self-ignition of the fuel/flue gas mixture formed in the mixture formation zone may become a problem. Such self-ignition before the mixture enters the catalyst results in sooting up of the system due to the unselective reaction of the fuel, resulting in a diminished yield and shortened useful life of the reformer. Futhermore, excessively high temperatures materialize in the entry portion of the reforming zone. To get round this problem it has already been proposed to reduce the mixing formation temperature down to below the ignition temperature for the mixture. For this purpose, additional media flows are needed as cooling media, resulting in the overall system becoming unwantedly complicated.

The invention is based on the object of sophisticating a reformer such that unwanted self-ignition in a mixture formation zone is now simply eliminated.

This object is achieved by the features of the independent claim.

Advantageous embodiments of the invention read from the dependent claims.

The invention is a sophistication over the generic reformer in that the volume of the mixture formation zone is in the range of 20 to 90 cm³. By suitably selecting the volume of the mixture formation zone it is achieved that self-ignition is now avoided simply on the basis of the dynamics of the media flowing through the reformer, i.e. cooling is no longer needed.

It is particularly expedient that the volume of the mixture formation zone is in the range of 40 to 60 cm³.

In conjunction with such volumes of the mixture formation zone it is advantageously provided for that the reformer is suitable to receive a flue gas flow rate in the range of 40 to 200 l/min.

A flue gas flow in this range in conjunction with the cited volume range of the mixture formation zone results in the flue gas flow rate being resident in the mixture formation zone in the range of 10 to 100 ms. A residence time in this range is in the order of magnitude of average time range of delayed ignition as is typical for mixtures generated in the mixture formation zone. When the residence time as compared to the time for self-ignition is sufficiently short a self-ignition can be reliably suppressed. This is also achievable on the condition that the reformer can be operated at a temperature in the range of 700 to 950° C. in the mixture formation zone, these being temperatures as typically existing in the mixture formation zone without further intervention.

The invention is based on having discovered that simply suitably selecting the volume of the mixture formation zone permits avoiding self-ignition of the mixture in the mixture formation zone. Specifying the volumes involved serves particularly in realizing typical applications and a system performance in the range of 2 to 5 kW as can be made available by making use of the cited flue gas flow rates.

The invention will now be detailed by way of a preferred embodiment with reference to the attached drawings in which:

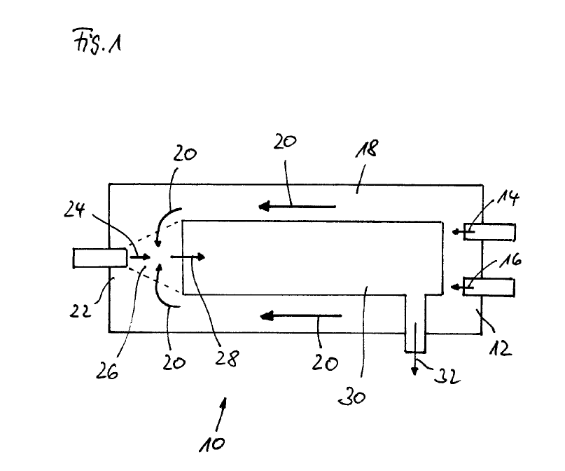

FIG. 1 is a diagrammatic representation provided for a reformer in accordance with the invention.

Referring now to FIG. 1 there is illustrated how the reformer 10 has a first media feeder portion 12 receiving a supply of fuel 14 and oxidant 16, i.e. particularly air. The first media feeder portion 12 is followed by an oxidation zone 18 in which the media feed is reacted at least in part so that flue gas 20 materializes. The resulting flue gas 20 then gains access to a mixture formation zone 26. The mixture formation zone 26 receives a further supply of fuel 24 via a second media feeder portion 22, resulting in a fuel/flue gas mixture 28 which is then supplied to a reforming zone 30. In the reforming zone 30 the fuel/flue gas mixture is catalytically reformed to ultimately be output as reformate 32. The reformate 32 can then be made available to further applications, particularly to a fuel cell.

In accordance with the present invention it is provided for that the mixture formation zone comprises a volume which prevents self-ignition of the fuel/flue gas mixture 28. Volumes which assuming a system output in the range of 2 to 5 kW are capable of achieving this are in the range of 40 to 60 cm³. In this arrangement it is not a mandatory requirement that the mixture formation zone is in a precisely defined range, for, instead, it is generally so that the mixture formation zone smoothly translates into the oxidation zone 18, the reforming zone 30 and the second media feeder portion 22. However, as an alternative, it is just as possible to precisely define the mixture formation zone by suitably precisely designing the volume of the reformer so as to safely prevent the unwanted effect of self-ignition. This is achievable, for example, by including orifices or other conduit means tweaking the zone for forming the mixture in thus achieving a precise definition of the volume of the mixture formation zone.

It is understood that the features of the invention as disclosed in the above description, in the drawings and as claimed may be essential to achieving the invention both by themselves or in any combination.

### LIST OF REFERENCE NUMERALS

10 reformer

12 media feeder portion

14 fuel

16 oxidant

18 oxidation zone

20 flue gas

22 media feeder portion

24 fuel

26 mixture formation zone

28 fuel/flue gas mixture

30 reforming zone 32 reformate

1. A reformer comprising
a first media feeder portion for receiving a supply of fuel and oxidant 6,
following the first media feeder portion an oxidation zone in which the media supplied to the first media feeder portion react at least in part into flue gas,
a second media feeder portion for receiving at least a supply of fuel,
a mixture formation zone following the oxidation zone and the second media feeder portion and in which a fuel/flue gas mixture can be generated, and
following the mixture formation zone a reforming zone in which the fuel/flue gas mixture is catalytically reformable,
wherein the volume of the mixture formation zone is in the range of 20 to 90 cm³.

2. The reformer of claim 1, wherein the volume of the mixture formation zone is in the range of 40 to 60 cm³.

3. The reformer claim 1, wherein the reformer is suitable to receive a flue gas flow rate in the range of 40 to 200 l/min.

4. The reformer of claim 1, wherein the flue gas flow rate is resident in the mixture formation zone in the range of 10 to 100 ms.

5. The reformer of claim 1, wherein the reformer can be operated at a temperature in the range of 700 to 950° C. in the mixture formation zone.
